(19) United States
(12) Patent Application Publication
(10) Pub. No.: US 2012/0177275 A1
(43) Pub. Date: Jul. 12, 2012

(54) Coronary Artery Disease Prediction using Automated IMT

(76) Inventor: Jasjit S. Suri, Roseville, CA (US)

(21) Appl. No.: 13/407,602

(22) Filed: Feb. 28, 2012

Related U.S. Application Data
(63) Continuation-in-part of application No. 12/799,177, filed on Apr. 20, 2010.
Application No. 12/799,177 is a continuation-in-part of application No. 12/802,431, filed on Jun. 7, 2010.
Application No. 12/802,431 is a continuation-in-part of application No. 12/896,875, filed on Oct. 2, 2010.
Application No. 12/896,875 is a continuation-in-part of application No. 12/960,491, filed on Dec. 4, 2010.
Application No. 12/960,491 is a continuation-in-part of application No. 13/053,971, filed on Mar. 22, 2011.
Application No. 13/053,971 is a continuation-in-part of application No. 13/077,631, filed on Mar. 31, 2011.
Application No. 13/077,631 is a continuation-in-part of application No. 13/107,935, filed on May 15, 2011.
Application No. 13/107,935 is a continuation-in-part of application No. 13/219,695, filed on Aug. 28, 2011.
Application No. 13/219,695 is a continuation-in-part of application No. 13/253,952, filed on Oct. 5, 2011.
(60) Provisional application No. 61/525,745, filed on Aug. 20, 2011.

(51) Int. Cl. G06K 9/62

(52) U.S. Cl. 382/131

(57) ABSTRACT

A system (AtheroEdgeLink™) that links and predicts the Syntax Score for Coronary Artery Disease Patients using carotid IMT in Ultrasound. Ultrasound is acquired for the carotids and CIMT is estimated using AtheroEdge™. For the same images, plaque burden or plaque score is estimated. Syntax score is estimated from cardiac X-ray angiograms. The AtheroEdgeLink™ technique correlates between CIMT computed using AtheroEdge™ and Syntax Score. The system AtheroEdgeLink™ can help compute the ROC area under the curve (Az) between CIMT and Syntax Score for Coronary Artery Disease patients. Such a system can also help to find the specificity of finding the threshold on CIMT for associating the presence of Coronary Artery Disease.

### PRIORITY APPLICATIONS

This is a continuation-in-part patent application of co-pending patent application Ser. No. 12/799,177; filed Apr. 20, 2010 by the same applicant. This is also a continuation-in-part patent application of co-pending patent application Ser. No. 12/802,431; filed Jun. 7, 2010 by the same applicant. This is also a continuation-in-part patent application of co-pending patent application Ser. No. 12/896,875; filed Oct. 2, 2010 by the same applicant. This is also a continuation-in-part patent application of co-pending patent application Ser. No. 12/960,491; filed Dec. 4, 2010 by the same applicant. This is also a continuation-in-part patent application of co-pending patent application, Ser. No. 13/053,971; filed Mar. 22, 2011 by the same applicant. This is also a continuation-in-part patent application of co-pending patent application, Ser. No. 13/077,631; filed Mar. 31, 2011 by the same applicant. This is also a continuation-in-part patent application of co-pending patent application, Ser. No. 13/107,935; filed May 15, 2011 by the same applicant. This is also a continuation-in-part patent application of co-pending patent application, Ser. No. 13/219,695; filed Aug. 28, 2011 by the same applicant. This is also a continuation-in-part patent application of co-pending patent application, Ser. No. 13/253,952; filed Oct. 5, 2011 by the same applicant. This present patent application draws priority from the referenced co-pending patent applications. This present patent application also draws priority from the provisional patent application Ser. No. 61/525,745; filed Aug. 20, 2011 by the same applicant. The entire disclosures of the referenced co-pending patent applications and the provisional patent application are considered part of the disclosure of the present application and are hereby incorporated by reference herein in its entirety.

### TECHNICAL FIELD

This application relates to a method and system for use with data processing and imaging systems, according to one embodiment, and more specifically, for enabling automated Atherosclerosis imaging.

### BACKGROUND

Coronary Artery Disease is condition when the blood vessels that supply blood and oxygen to the heart are narrowed and damaged. These blood vessels are damaged by the presence of plaque which includes fat, cholesterol, calcium. Due to excess of plaque build-up in these arteries, causes a condition called “Atherosclerosis”. Due to the blockage of the blood flow, leads to the condition called “heart attack”. The blocking of the Coronary Artery can lead to serious heart problem which includes Heart Attack and Heart Failure. Heart Attack or Myocardial Infarction happens when the coronary arteries are blocked and does not have a capacity to supply blood to the heart muscle for pumping. Heart Attack can be mild or severe depending upon the damage condition. Also due to lack of the blood supply to the heart muscle, it can affect the electrical impulses heading to abnormal heart rhythms or also called as abnormal heart beats. Heart Failure is also a condition when the blood flow is reduced and the heart has no ability to pump enough blood to the rest of the body.

Thus identification of Coronary Artery Disease patients is an important field of Cardiology. Coronary Artery Disease is one of the leading causes of death in USA and it is estimated about 80 million American Adults have one or more types of cardiovascular disease.

The SYNTAX score (SXscore), is an angiographic score that reflects coronary lesion complexity and it is used to predict clinical outcomes in patients with single or multivessel disease. The SXscore was pioneered as an anatomical-based risk score that helped in the decision-making process and it is demonstrated that this parameter correlates with the prognosis among patients who underwent coronary revascularization.

In previous studies such as Ikeda N, Kogame N, Iijima R, Nakamura M, Sugi K. Carotid artery intima-media thickness and plaque score can predict the SYNTAX score. Eur Heart 2012; 33 (1): 113-9, it was found that CIMT and Plaque Score (PS) or Plaque Burden have predictive value for the SXscore and that PS and Carotid LMT (CIMT) had excellent negative predictive value for the presence of complex coronary artery lesions. One of the main limitations in the use of the manually calculated IMT as this leads to sub-optimal reproducibility that can determine a bias in the risk quantification for a subject.

Carotid IMT (CIMT) is the well established marker for early staging of the Atherosclerotic disease and it is also associated with the development of the cardiovascular events and cardiovascular outcomes. IMT is generally adapted for this and is used by measuring the distance between the LI and MA interfaces. This can be done using manual calipers or semi-automatically. Recently, research is actively involved where IMT measurement needs to be become automated. Important systems like CAMES, CALEX, CALSFORM, CARES, CMUDS has been recently adapted. These methods are discussed in detail in: (a) Molinari F, Liboni W, Giustetto P, Badalamenti S, Suri J S. Automatic computer-based tracings (ACT) in longitudinal 2-D ultrasound images using different scanners. Journal of Mechanics in Medicine and Biology. 2009; 9:481-505; (b) Molinari F, Meiburger K M, Zeng G, Acharya U R, Liboni W, Nicolaides A, Suri J S. Carotid artery recognition system: A comparison of three automated paradigms for ultrasound images. Med Phys. 2012; 39:378; (c) Molinari F, Pattichis C, Zeng G, Saba L, Acharya U, Sanfilippo R, et al. Completely Automated Multi-resolution Edge Snapper (GAMES) inverted question mark A New Technique for an Accurate Carotid Ultrasound IMT Measurement: Clinical Validation and Benchmarking on a Multi-Institutional Database. IEEE Trans Image Process., 2012; (d) Molinari F, Krishnamurthi G, Acharya R U, Sree S V, Zeng G, Saba L, et al. Hypothesis validation for far wall brightness in carotid artery ultrasound for feature-based IMT measurement using combination of level set segmentation & registration. IEEE Trans Instrumentation & Measurement, 2012.

Coronary artery lesion complexity can be predicted by the Syntax Score (SXscore) from the angiography images and is used for prediction of clinical outcomes for this multi-vessel disease. This SXscore has been adapted as an anatomical landmark risk score for coronary artery disease patients. This parameter has been studied as a prognosis for patients who undergo coronary revisualization. The innovative system called AtheroEdgeLink™ is used to link and predict the CIMT and Syntax Score in Coronary Artery Disease patients. Such a system can also help to find the specificity of finding the threshold on CIMT for associating the presence of Coronary Artery Disease.

This application is a novel method (called AtheroEdgeLink™) to automatically link and predict the SXscore using automated CIMT using Coronary Artery Disease patients. Automated CIMT is key in accessing and linking and predicting the Syntax Score (SXscore).

### BRIEF DESCRIPTION OF THE DRAWINGS

The various embodiments is illustrated by way of example, and not by way of limitation, in the figures of the accompanying drawings in which:

FIG. 1 illustrates an example of AtheroEdgeLink™ system.

FIG. 2 shows an illustrative example of location of plaque build-up in the Carotid Artery.

FIG. 3A and FIG. 3B shows an illustrative example of LI interface and MA interface information in B-mode or RF-ultrasound image.

FIG. 4 shows an illustrative example for CIMT computation using AtheroEdge™ processor.

FIG. 5 shows the sample example of the coronary X-ray images.

FIG. 6 shows the illustrative flow chart for Syntax Score Processor.

FIG. 7 shows the illustrative example of how the Plaque Score or Plaque Burden is computed in B-mode or RF ultrasound Carotid image using an iterative process.

FIGS. 8A and 8B show the illustrative results of the AtheroEdge™ processor.

FIG. 9 shows illustrative relationship plot of Syntax Score and automated CIMT.

FIG. 10 shows an illustrative result of Sensitivity vs. Specificity for Automated CIMT.

FIG. 11A shows an illustrative example of the relationship between plaque score and syntax score.

FIG. 11B shows the threshold analysis of the ROC curve for CIMT.

FIG. 12 shows an illustrative example of Sensitivity vs. Specificity for Plaque Score.

FIG. 13 shows an illustrative example of computing CIMT using CALEX processor.

FIG. 14 shows an illustrative example of computing CIMT using CARES processor.

FIG. 15 shows an illustrative example of computing CIMT using CMUDS processor.

FIG. 16 shows an illustrative example of computing CIMT using CALSFORM processor.

FIG. 17 shows the overall view of the system.

FIG. 18 shows an illustrative example of linking and predicting the Syntax Score using Carotid MR or CT Carotid Artery Wall Thickness (CWAT) and its corresponding MR/CT Plaque Burden.

FIG. 19 shows a diagrammatic representation of machine in the example form of a computer system within which a set of instructions when executed may cause the machine to perform any one or more of the methodologies discussed herein.

### DETAILED DESCRIPTION

Major cause of morbidity and mortality in developed countries is the Atherosclerosis of Carotid Artery. In order for setting the therapies in symptomatic patients, it is very important to identify the reliable markers. CIMT is the well established marker for early staging of the Atherosclerotic disease and it is also associated with the development of the cardiovascular events and cardiovascular outcomes.

In recent years, the possibility of adopting a composite thickness of the tunica intima and media, i.e., an intima-media thickness (hereinafter referred to as an “IMT”) of carotid arteries, as an index of judgment of arterial sclerosis has been studied. Conventional methods of imaging a carotid artery using an ultrasound system, and measuring the IMT using an ultrasonic image for the purpose of diagnosis are being developed.

A conventional measuring apparatus can measure an intima-media thickness of a blood vessel using an ultrasound device to scan the blood vessel. Then, for example, an image of a section of the blood vessel including sections of the intima, media and adventitia is obtained. The ultrasound device further produces digital image data representing this image, and outputs the digital image data to a data analyzing device.

The intima, media and adventitia can be discriminated on the basis of changes in density of tissue thereof. A change in density of tissue of the blood vessel appears as a change of luminance values in the digital image data. The data analyzing device detects and calculates the intima-media thickness on the basis of the changes of luminance values in the digital image data. The digital image data can include a plurality of luminance values each corresponding to respective one of a plurality of pixels of the image. The data analyzing device can set a base position between a center of the blood vessel and a position in a vicinity of an inner intimal wall of the blood vessel on the image, on the basis of a moving average of the luminance values. The data analyzing device can detect a maximum value and a minimum value from among the luminance values respectively corresponding to a predetermined number of the pixels arranged from the base position toward a position of an outer adventitial wall on the image. The data analyzing device can then calculate the intima-media thickness on the basis of the maximum value and the minimum value.

IMT is generally adapted for this and is used by measuring the distance between the LI and MA interfaces. This can be done using manual calipers or semi-automatically. Recently, research is actively involved where IMT measurement needs to be become automated. Important systems like CAMES, CALEX, CALSFORM, CARES, CMUDS has been recently adapted. Coronary artery lesion complexity can be predicted by the Syntax Score (SXscore) from the angiography images and is used for prediction of clinical outcomes for this multi-vessel disease. This SXscore has been adapted as an anatomical landmark risk score for coronary artery disease patients. This parameter has been studied as a prognosis for patients who undergo coronary revisualization. The system called AtheroEdgeLink is used to compute CIMT and link and predict the Syntax Score in CAD patients. Such a system can also help to find the specificity of finding the threshold on CIMT for associating the presence of Coronary Artery Disease.

### Detailed Methodology of the System of an Example Embodiment

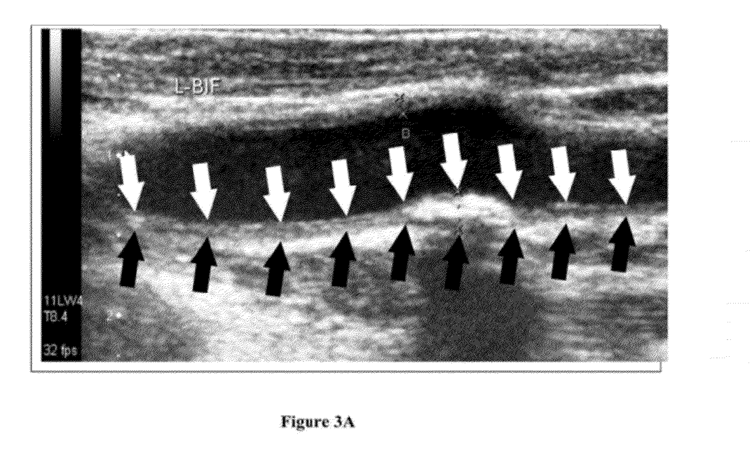

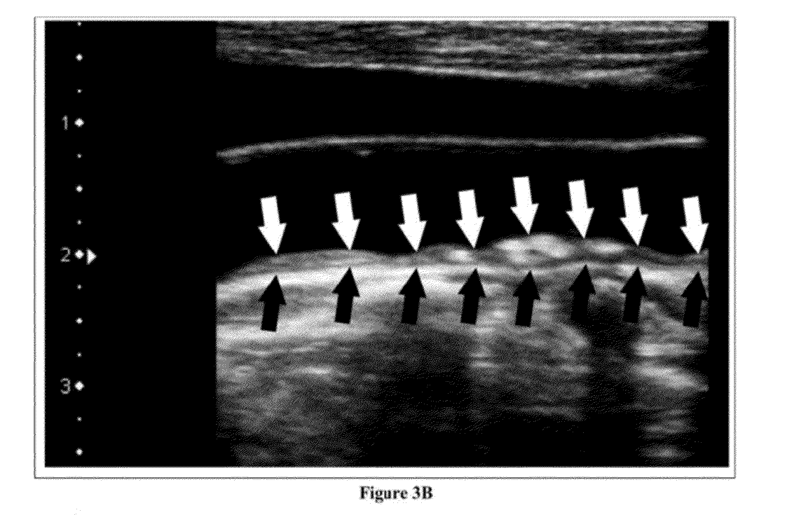

This invention is a system for linking and predicting the Syntax Score in Coronary Artery Disease patients via the automated CIMT measurement system. Those skilled in the art will know how to acquire the common carotid artery ultrasound and internal carotid artery ultrasound images. Once the carotid artery is located in the transverse scan, the probe can be titled to ninety degrees to acquire the longitudinal anterior and posterior ultrasound image. Those skilled in the art of the carotid ultrasound image acquisition know that this can follow the guidelines and recommendation of American Society of Echocardiography Carotid Intima Media Thickness Task Force as recommended in this publication “Stein J H, Korcarz C E, Hurst R T, Lonn E, Kendall C B, Mohler E R, Najjar S S, Rembold C M, Post W S, Force ASoECI-MTT. Use of carotid ultrasound to identify subclinical vascular disease and evaluate cardiovascular disease risk: a consensus statement from the American Society of Echocardiography Carotid Intima-Media Thickness Task Force. Endorsed by the Society for Vascular Medicine. J Am Soc Echocardiogr 2008; 21:93-111; quiz 189-90”. An illustrative example of the ultrasound B-mode or RF mode image is shown in FIGS. 3A and 3B.

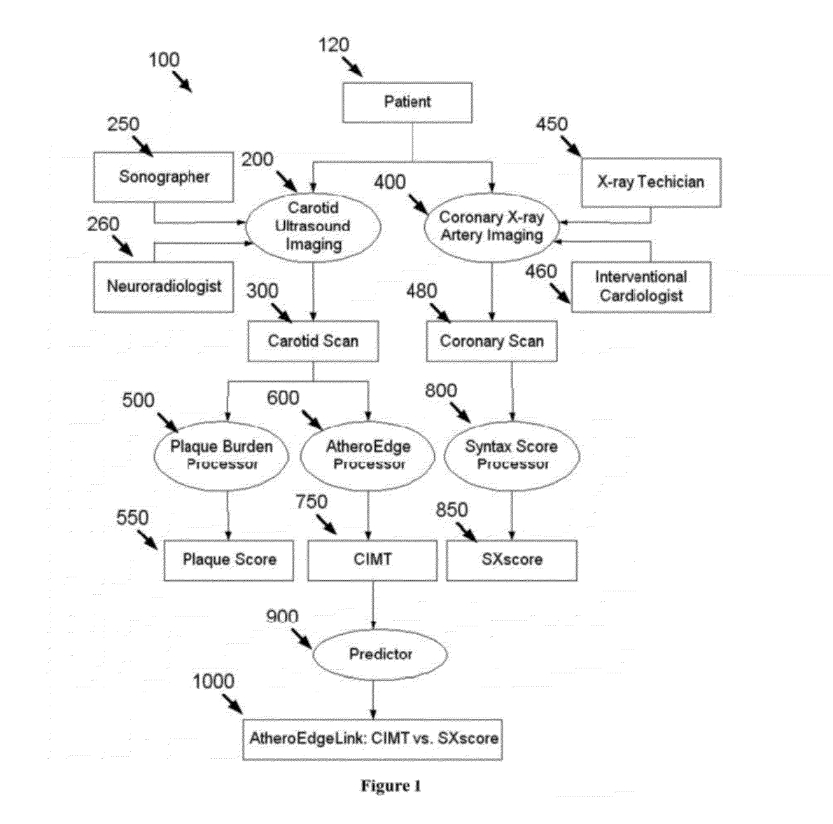

Plaque Score (PS) or Plaque Burden can be estimated in CCA or ICA in B-mode or RF-mode ultrasound images. For illustrative purpose and depiction, the PS can be seen for the regions A, B and C in the representative carotid image in FIG. 1. Those skilled in the art will immediately know that the PS can be computed at the proximal end or distal end of the carotid bulb. This can be as large as 1.5 cm or 15 mm regions. An example of computing the plaque score can be seen in the following publication “Ikeda N, Kogame N, Iijima R, Nakamura M, Sugi K. Carotid artery intima-media thickness and plaque score can predict the SYNTAX score. Eur Heart J 2012; 33 (1): 113-9”. Plaque can be considered as a focal intima-media thickening greater than equal to 1.1 mm and the plaque score (PS) can be calculated' by adding the maximal thickness in millimetres of plaques in each segment on right and left carotid arteries. An illustrative example can be given in FIG. 1 with 4 segments: Segment 1 is the region of the Internal Carotid Artery (ICA) that is less than 15 mm distal to its bifurcation from Common Carotid Artery (CCA). Segment 2 is the pixel region of the ICA and the CCA that is less than 15 mm proximal to the bifurcation. Segment 3 is the region of the CCA is greater than 15 mm and less than 30 mm proximal to the bifurcation whereas segment 4 is the region of the CCA that was greater than 30 mm proximal to the bifurcation and below the flow divider. This plaque score has a relationship with both CIMT and Syntax Score of the Coronary Artery Disease Patients. This innovation has a methodology for development of the link between automated computation of the CIMT and Syntax Score of the Coronary Artery Disease Patients. This link is in the form of the prediction of the Syntax Score via the automated CIMT. An example of the carotid B-mode or RF-mode ultrasound scan can be seen in the FIGS. 3A and 3B. The white arrows show the Lumen-Intima (LI) Borders and Black Arrows shows the edges of the Media-Adventita (MA) Borders.

The system block 100 shows the entire system called AtheroEdgeLink™ which establishes the automated CIMT computation with Syntax Score and Plaque Score of the patient. Carotid Ultrasound Imaging Processor 200 is used for scanning the carotid or blood vessel image of the patient. This is a standard procedure for scanning the CCA, ICA or ECA of the carotids. Sonographer 250 or neuroradiologist 260 is normally involved in the scanning process. Those skilled in the art can use the same protocol for other blood vessels such as Aortic Arch, Brachial Artery or Peripheral Artery and the same system can be used for these kinds of arteries as well.

The system block 100 also shows the processor 400 called Coronary Artery X-ray imaging for imaging the coronaries of the heart. This processor yields the output 480. X-ray technician 450 and interventional cardiologist 460 are normally involved in the scanning process.

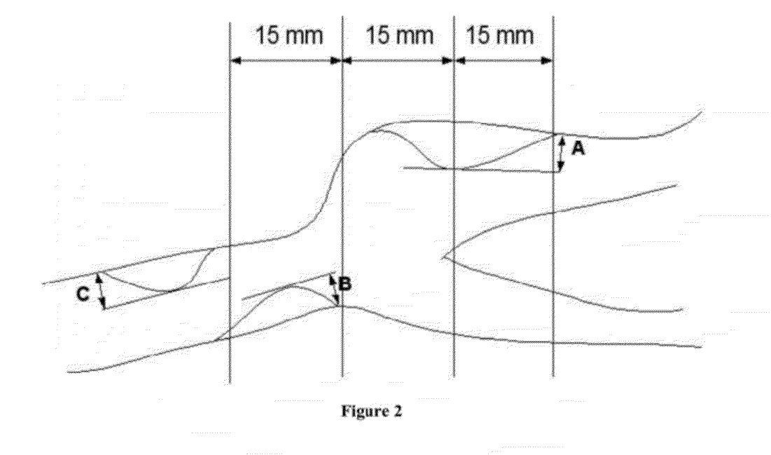

Processor 500 is used for computing the plaque score or plaque burden in the CCA or ICA arteries of the carotid. This processor inputs the carotid scan 300 which is the output of the processor 200. Processor 500 is applied on the Carotid B-mode or RF ultrasound image as described in the carotid image in FIG. 2 and represented for the regions A, B and C.

AtheroEdge™ Processor 600 is used for computation of the CIMT. It accepts the input 300 as a carotid scan image and outputs the CIMT values of the distal wall. The current invention lies in the methodology on automated CIMT computation and predicting the Syntax Score in the Coronary Artery Disease Patients. The AtheroEdge™ processor used CALEX, CAMES, CARES, CALSFORM, CMUDS systems for computing the LI/MA interfaces and then computing the CIMT values. These methods are discussed in detail in: (a) Molinari F, Liboni W, Giustetto P, Badalamenti S, Suri J S. Automatic computer-based tracings (ACT) in longitudinal 2-D ultrasound images using different scanners. Journal of Mechanics in Medicine and Biology. 2009; 9:481-505; (b) Molinari F, Meiburger K M, Zeng G, Acharya U R, Liboni W, Nicolaides A, Suri J S. Carotid artery recognition system: A comparison of three automated paradigms for ultrasound images. Med Phys. 2012; 39:378; (c) Molinari F, Pattichis C, Zeng G, Saba L, Acharya U, Sanfilippo R, et al. Completely Automated Multi-resolution Edge Snapper (CAMES) inverted question mark A New Technique for an Accurate Carotid Ultrasound IMT Measurement: Clinical Validation and Benchmarking on a Multi-Institutional Database. IEEE Trans Image Process., 2012; (d) Molinari F, Krishnamurthi G, Acharya R U, Sree S V, Zeng G, Saba L, et al. Hypothesis validation for far wall brightness in carotid artery ultrasound for feature-based IMT measurement using combination of level set segmentation & registration. IEEE Trans Instrumentation & Measurement, 2012.

Syntax Score Processor block 800 is used for computation of Syntax Score, given the coronary scan of the Coronary Artery Disease Patient. The output of the block is the Syntax score value 850. Those skilled in the art of Syntax Score can use any of the standard methods for Syntax Score computation as discussed in these publications: (a) Scherff F, Vassalli G, Sürder D, Mantovani A, Corbacelli C, Pasotti E, Klersy C, Auricchio A, Moccetti T, Pedrazzini G B. The SYNTAX score predicts early mortality risk in the elderly with acute coronary syndrome having primary PCI. J Invasive Cardiol 2011; 23 (12): 505-10; (b) Brito J, Teles R, Almeida M, de Araújo Gonsalves P, Raposo L, Sousa P, Mendes M. Predictive value of SYNTAX score in risk stratification of patients undergoing unprotected left main coronary artery angioplasty. J Invasive Cardiol 2011; 23 (12): 494-9.

Processor 900 is the link or prediction processor which links to the automated CIMT values to the Syntax score values. Further it is this processor which computes the sensitivity vs. specificity for the automated CIMT and sensitivity vs. specificity for the Plaque Score. Further, the Processor 900 also gives the relationship between the Syntax Score and Automated CIMT for the Coronary Artery Disease Patients. Further, this processor helps to find the specificity of finding the threshold on CIMT for associating the presence of Coronary Artery Disease.

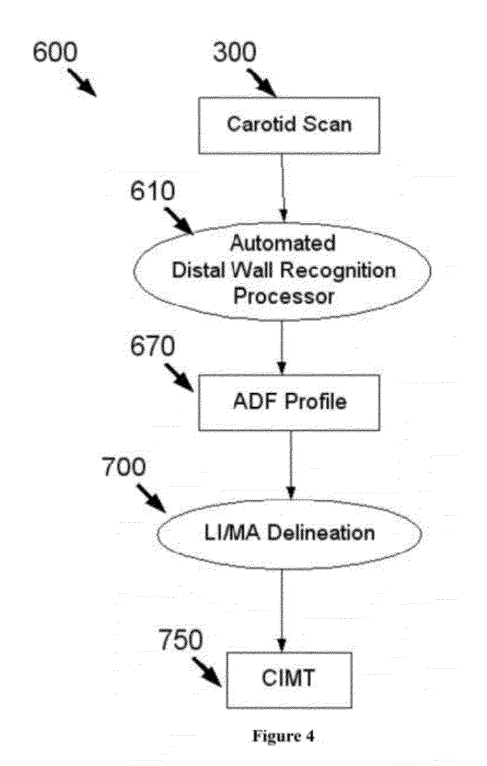

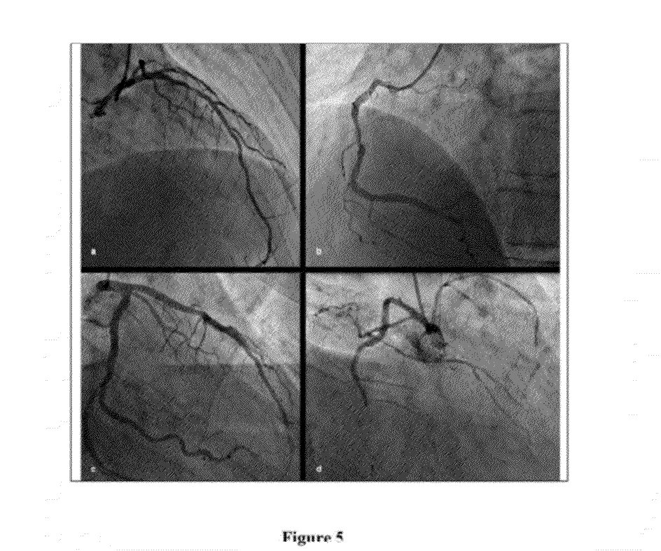

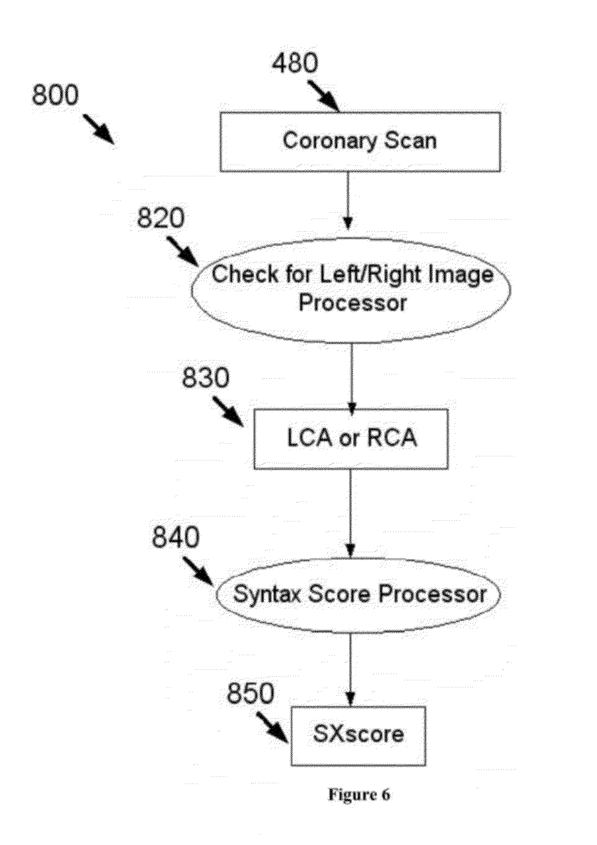

FIG. 4 shows an illustrative processor 600 for computation of automated CIMT. Processor 610 is used for automated far wall (ADF) delineation which gives the output 670. These initial borders are then used for computing the LI/MA interfaces using the processor 700 followed by the CIMT measurements. Those skilled in the art can use another method for computation of LI/MA interfaces.

Processor 800 is used for Syntax Score. The Coronary Scan is obtained using the processor 480. Processor 820 checks for left or right coronary scan and give the output 830. Syntax Score Processor 840 is then used for computation of Syntax Score 850. Those skilled in the art of Syntax Score can use any of the standard methods for Syntax Score computation as discussed in these publications: (a) Scherff F, Vassalli G, Sürder D, Mantovani A, Corbacclli C, Pasotti E, Klersy C, Auricchio A, Moccetti T, Pedrazzini G B. The SYNTAX score predicts early mortality risk in the elderly with acute coronary syndrome having primary PCI. J Invasive Cardiol 2011; 23 (12): 505-10; (b) Brito J, Teles R, Almeida M, de Araújo Gonçalves P, Raposo L, Sousa P, Mendes M. Predictive value of SYNTAX score in risk stratification of patients undergoing unprotected left main coronary artery angioplasty. J Invasive Cardiol 2011; 23 (12): 494-9.

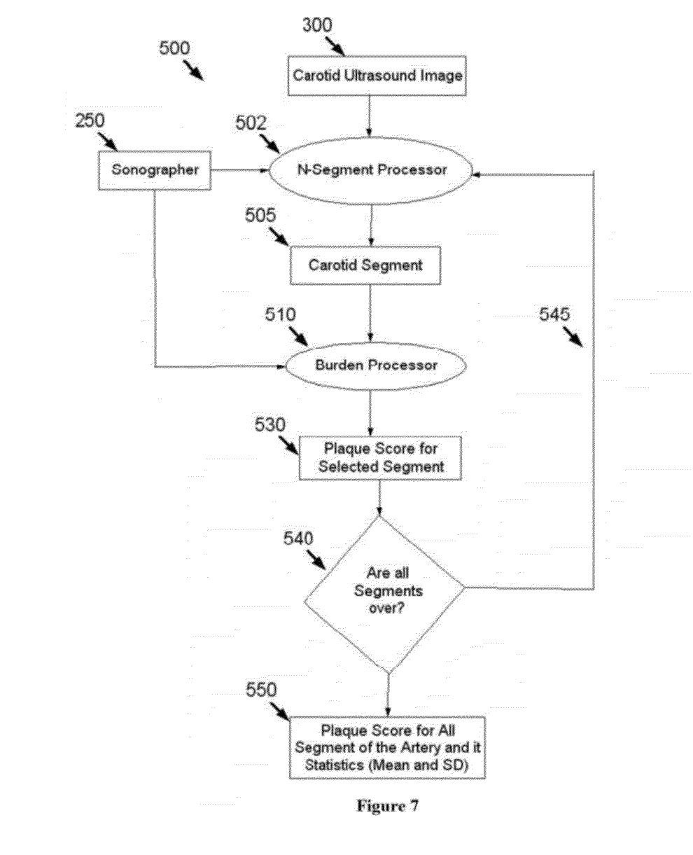

Processor 500 is discussed in FIG. 7 as an illustrative example to compute Plaque Burden or Plaque Score as discussed in representative picture FIG. 1. Carotid B-mode or RF ultrasound image is divided into segments 505 using N-segment processor 502. Burden processor 510 is executed with the aid of the sonographer 250 to give Plaque score 530 for each segment of the N-segment processor 502. The system checks for all, the segments at the check point 540. The feedback 545 is provided if plaque burden for all the N-segments are not over.

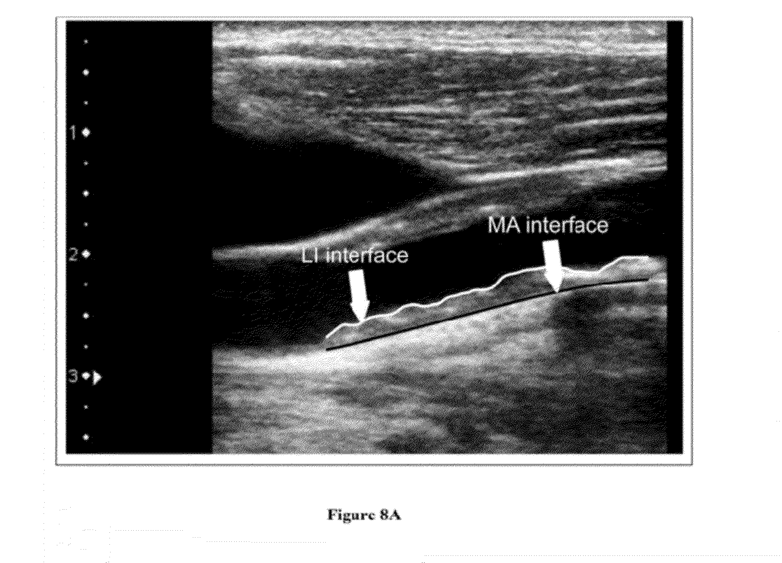

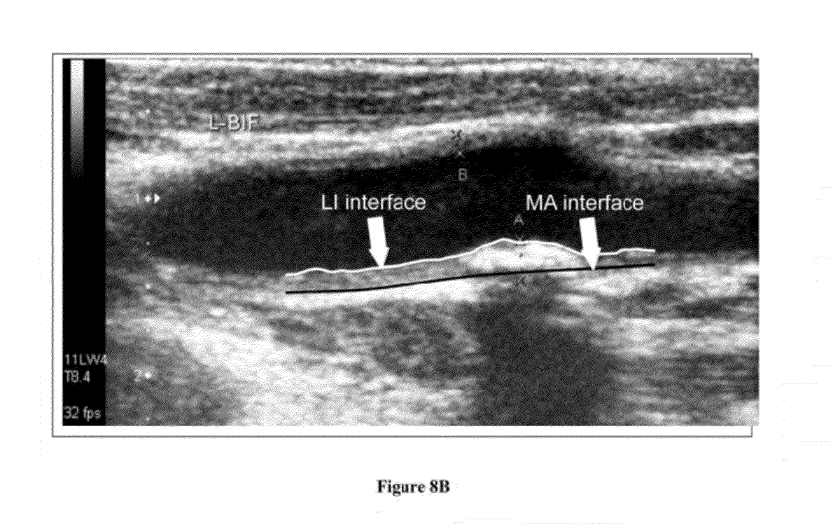

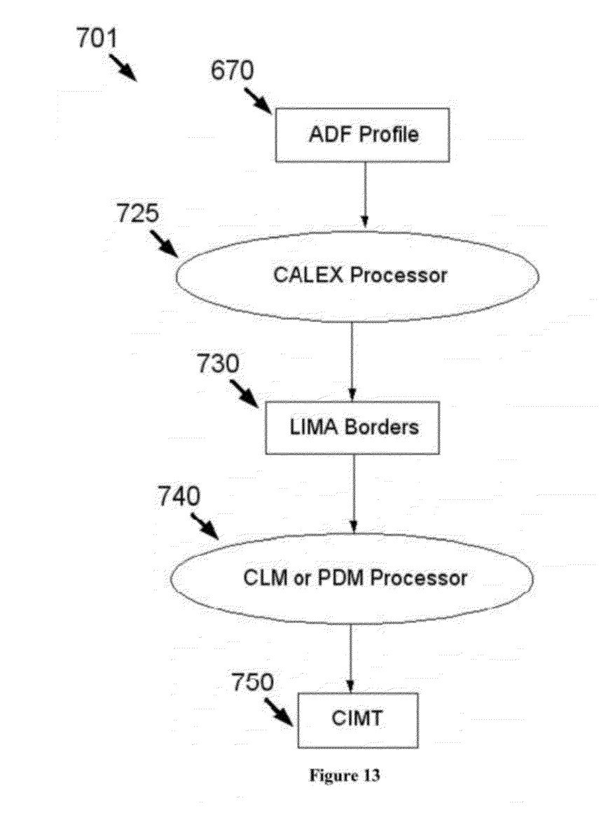

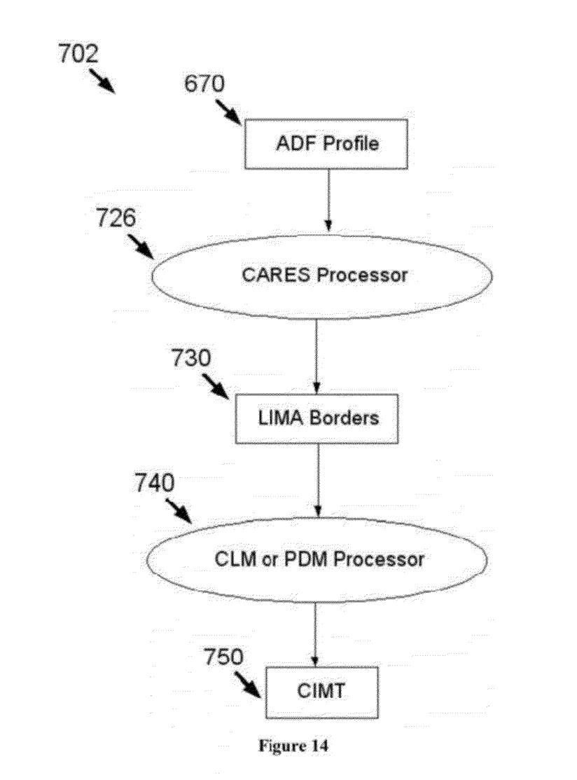

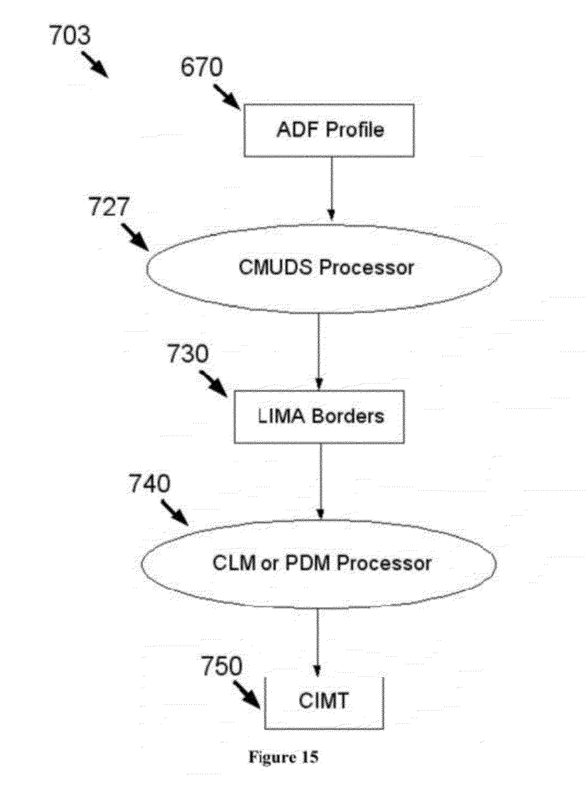

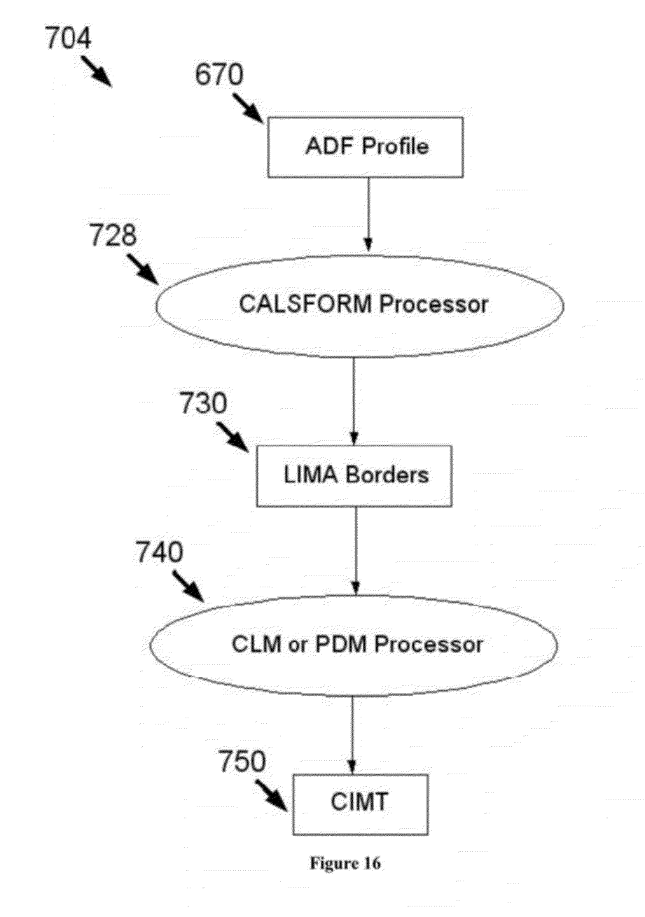

FIG. 8A and FIG. 8B shows the illustrative LI and MA delineations. Several methods are demonstrated such as CALEX, CAMES, CMUDS, CARES, CALSFORM that uses multi-resolution approach for ADF processor 670 followed by LIMA delineation using processor 700 (FIG. 4). Those skilled in the art can use CALEX processor 725 (FIG. 13) for estimating the LIMA Borders (FIG. 13) or CARES processor 726 (FIG. 14) or CMUDS processor 727 (FIG. 15) or CALSFORM processor 728 (FIG. 16). These methods are discussed in detail in: (a) Molinari F, Liboni W, Giustetto P, Badalamenti S, Suri J S. Automatic computer-based tracings (ACT) in longitudinal 2-D ultrasound images using different scanners. Journal of Mechanics in Medicine and Biology. 2009; 9:481-505; (b) Molinari F, Meiburger K M, Zeng G, Acharya U R, Liboni W, Nicolaides A, Suri J S. Carotid artery recognition system: A comparison of three automated paradigms for ultrasound images. Med Phys. 2012; 39:378; (c) Molinari F, Pattichis C, Zeng G, Saba L, Acharya U, Sanfilippo R, et al. Completely Automated Multi-resolution Edge Snapper (CAMES) inverted question mark A New Technique for an Accurate Carotid Ultrasound IMT Measurement: Clinical Validation and Benchmarking on a Multi-Institutional Database. IEEE Trans Image Process., 2012; (d) Molinari F, Krishnamurthi G, Acharya R U, Sree S V, Zeng G, Saba L, et al. Hypothesis validation for far wall brightness in carotid artery ultrasound for feature-based IMT measurement using combination of level set segmentation & registration. IEEE Trans Instrumentation & Measurement, 2012; (e) Rocha R, Campilho A, Silva J, Azevedo E, Santos R. Segmentation of the carotid intima-media region in B-Mode ultrasound images. Image and Vision Computing. 2010; 28:614-25.

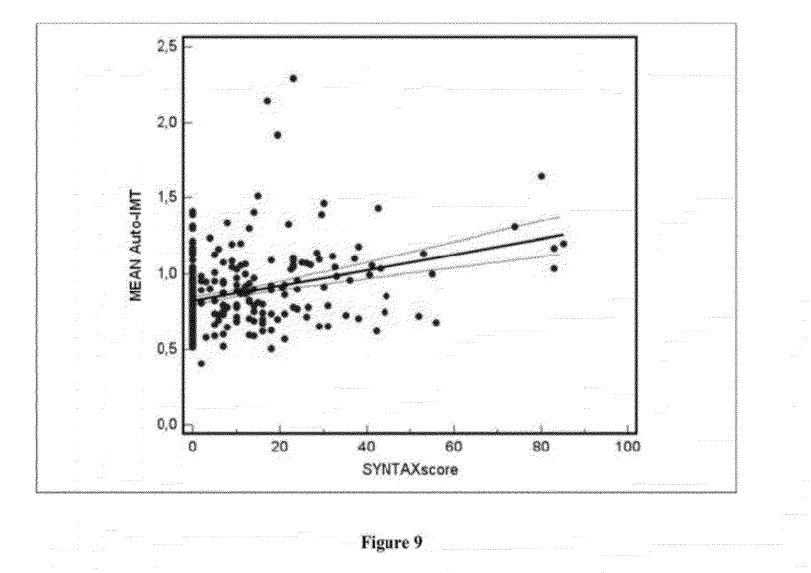

FIG. 9 shows the illustrative example of the relationship between the automated IMT in mm and Syntax Score from 0 to 100.

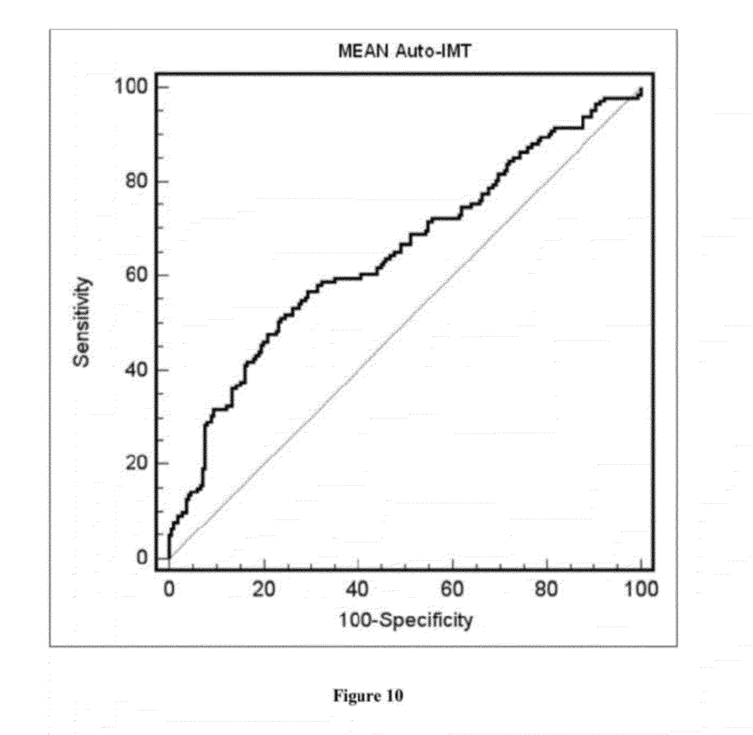

FIG. 10 shows the specificity vs. sensitivity relationship for the automated CIMT.

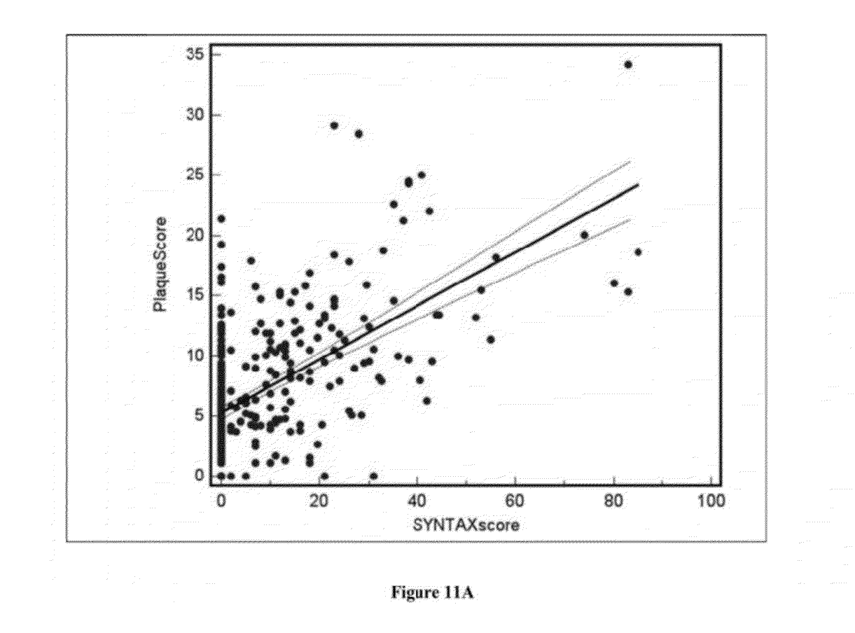

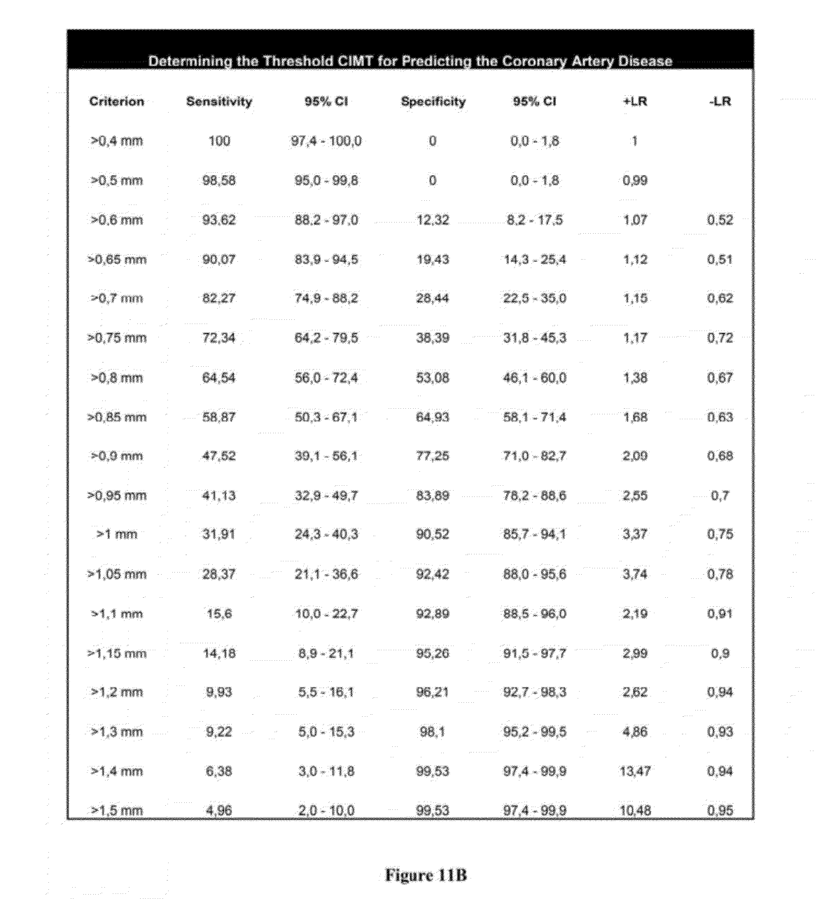

FIG. 11A shows the relationship between Plaque Score or Plaque Burden vs. Syntax Score.

FIG. 11B shows the threshold analysis of the ROC curve for CIMT. This illustrative example helps to find the specificity of finding the threshold on CIMT for associating the presence of Coronary Artery Disease.

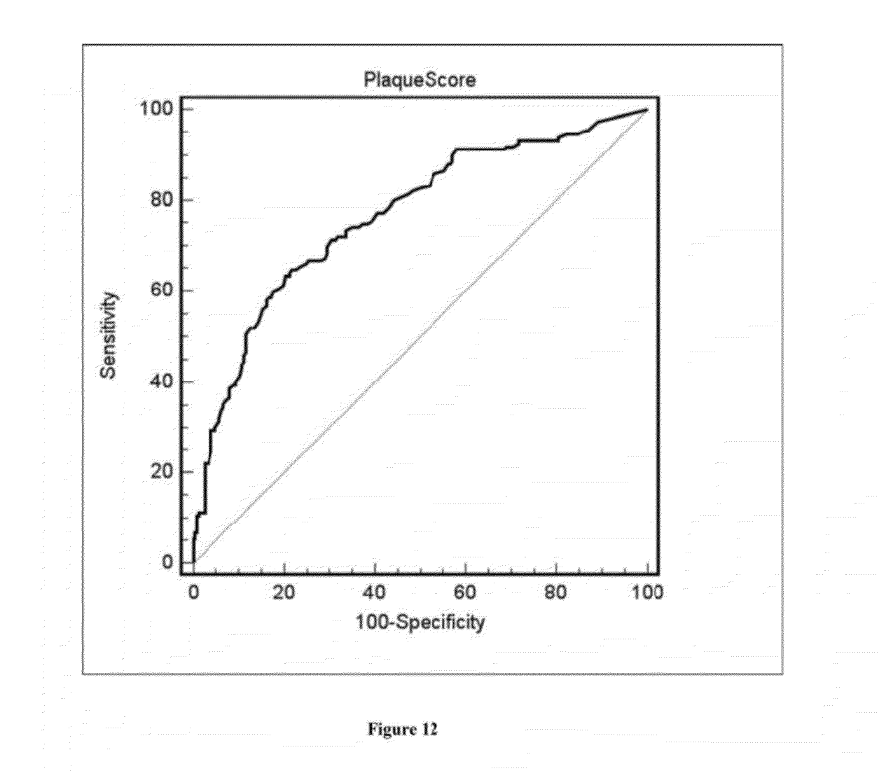

FIG. 12 shows the relationship of specificity vs. sensitivity of Plaque Score.

FIG. 13 shows the automated IMT computation method using the CALEX processor 725. CALEX processor has been well developed in the following paper “An Integrated Approach to Computer Based Automated Tracing and Its Validation for 200 Common Carotid Arterial Wall Ultrasound Images, J Ultrasound Med 2010; 29:399-418”. Processor 740 shows the centerline distance processor or polyline distance processor for computing the CIMT given the automated delineation for LI and MA borders using CALEX processor. FIG. 14 shows another method for computing the automated CIMT 750 using CARES processor 726. Those skilled in the art can also use a constrained-based method for computing the LI/MA borders as shown in the FIG. 15 using the CMUDS processor 727. Those skilled in the art for CIMT measurement can use CALSFORM processor 728 in FIG. 16.

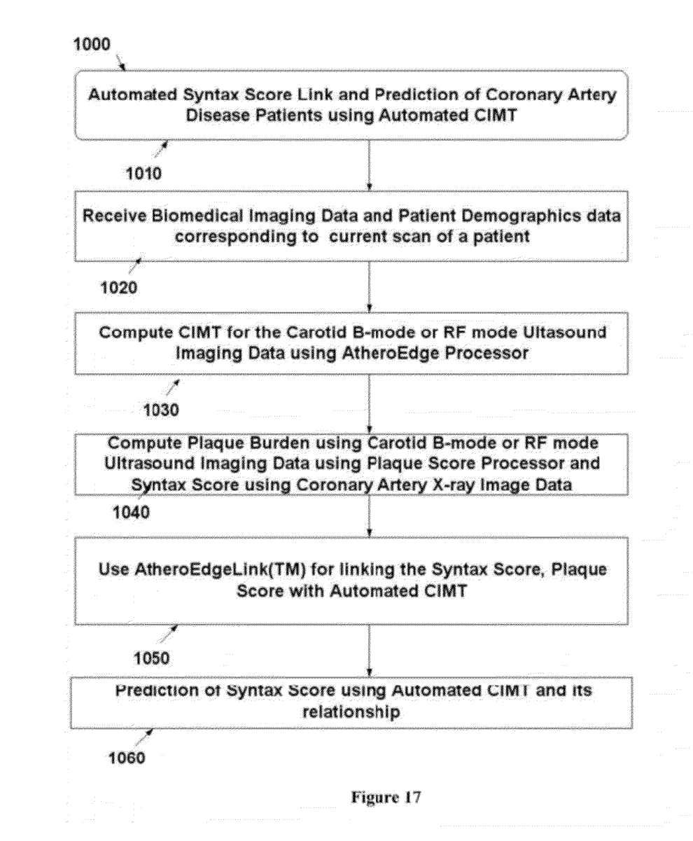

FIG. 17 shows the overall system for AtheroEdgeLink™ system. Those skilled in the art of CIMT measurement can use Carotid Wall Artery Thickness (CWAT) from CT or MRI and link that to Syntax Score of X-ray Coronaries. CWAT is the mean distance between the lumen wall and the outer wall in the cross-sectional slices of CT or MRI carotid scans. CWAT can be computed using standard methods or method discussed in the publication “Carotid Artery Wall Thickness Measured Using CT: Inter- and Intra-observer Agreement Analysis, American Journal of Neuroradiology, Vol. 34, 2011”. CWAT can also be manually computed as discussed in the publication: “Evaluation of Carotid Wall Thickness by Using Computed Tomography and Semiautomated Ultrasonographic Software, The Journal for Vascular Ultrasound 35(3):1-7, 2011”. A semi-automated method can also be used for computing CWAT in MRI or CT using a technique as discussed in publication: “A semi-automatic technique for measurement of arterial wall from black blood MRI, Hand M. Ladak, Jonathan B. Thomas, J. Ross Mitchell, Brian K. Rutt, and David A. Steinman, Med. Phys. 28 (6), 2001”. The same system AtheroEdgeLink™ can be applied for developing the link and prediction of Coronary Syntax Score using CWAT carotid CT or CWAT carotid MR and corresponding Plaque Scores.

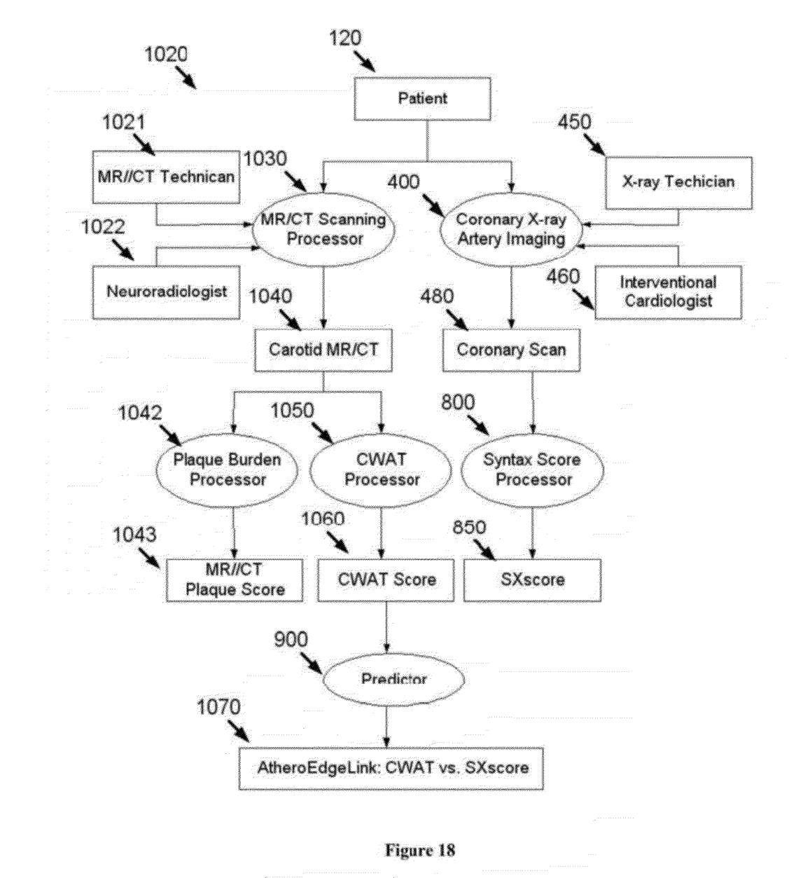

FIG. 18 shows the AtheroEdgeLink™ when MR/CT is used for linking the Syntax Score. CT/MR technician 1021 with the help of Neuroradiologist 1022 uses Processor 1030 for scanning the patient 120. The MR/CT output 1040 is used for computing CWAT score 1060 using the CWAT processor 1050. Similarly, the Plaque Burden processor 1042 is used for computing the Plaque Burden 1043. Predictor 900 is used for linking and predicting the Coronary Artery Syntax Score.

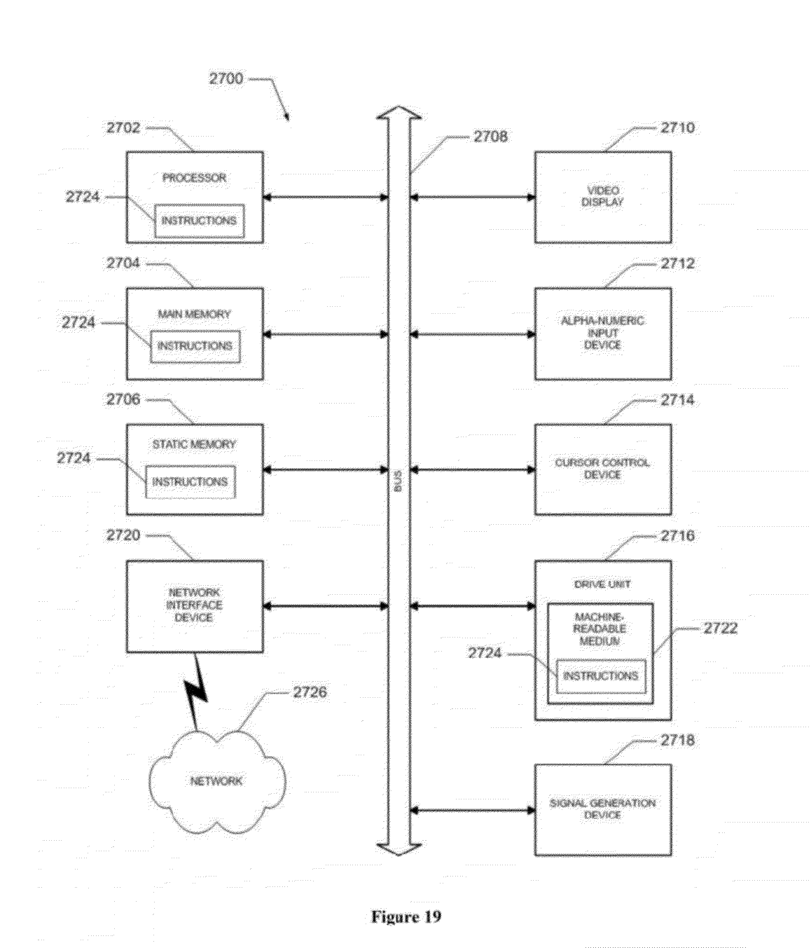

FIG. 19 shows a diagrammatic representation of machine in the example form of a computer system 2700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 2700 includes a processor 2702 (e.g., a central processing unit (CPU), a graphics processing unit (GPU), or both), a main memory 2704 and a static memory 2706, which communicate with each other via a bus 2708. The computer system 2700 may further include a video display unit 2710 (e.g., a liquid crystal display (LCD) or a cathode ray tube (CRT)). The computer system 2700 also includes an input device 2712 (e.g., a keyboard), a cursor control device 2714 (e.g., a mouse), a disk drive unit 2716, a signal generation device 2718 (e.g., a speaker) and a network interface device 2720.

The disk drive unit 2716 includes a machine-readable medium 2722 on which is stored one or more sets of instructions (e.g., software 2724) embodying any one or more of the methodologies or functions described herein. The instructions 2724 may also reside, completely or at least partially, within the main memory 2704, the static memory 2706, and/or within the processor 2702 during execution thereof by the computer system 2700. The main memory 2704 and the processor 2702 also may constitute machine-readable media. The instructions 2724 may further be transmitted or received over a network 2726 via the network interface device 2720. While the machine-readable medium 2722 is shown in an example embodiment to be a single medium, the term “machine-readable medium” should be taken to include a non-transitory single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather; as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented AtheroEdgeLink method comprising:
receiving carotid ultrasound data corresponding to a current scan of a patient;
using a data processor to process the biomedical imaging data corresponding to the current scan and to automatically generate Atherosclerosis burden or Plaque Score data corresponding to plaque levels on far (distal) walls and near (proximal) walls of a blood vessel of the patient;
using a data processor to process carotid ultrasound data corresponding to the current scan and to automatically generate Intima Media Thickness (Auto-IMT) of far (distal) walls or near (proximal) walls of a blood vessel of the patient;
receiving the Coronary X-ray Image of a patient;
using a data processor to process the biomedical imaging data corresponding to the current coronary scan and to automatically compute the Syntax Score or use the manual Syntax Score;
using a data processor to process to develop the relationship between automated CIMT from Carotid Ultrasound and Syntax Score from Coronary Scans and further to link and predict the Syntax Score using automated CIMT;
using a data processor to process to develop the relationship between automated CIMT from Carotid Ultrasound and Plaque Score from Carotid Ultrasound and further to link Automated CIMT with Plaque Score;
Compute the ROC area under the curve between CIMT and Coronary Artery Disease;
Estimate the specificity of finding the CIMT above a threshold (in mm) on patients with Coronary Artery Disease.

2. The method as claimed in claim 1 wherein the carotid ultrasound data comprises data in one of the forms from the group: two-dimensional (2D) longitudinal B-mode ultrasound images or two-dimensional (2D) longitudinal radio frequency (RF) ultrasound images.

3. The method as claimed in claim 1 where in the automated CIMT is computed using AtheroEdge™ system.

4. The method as claimed in claim 1 where in Plaque Score or Plaque Burden is computed using automated method or semi-automated method.

5. The method as claimed in claim 1 where in AtheroEdgeLink™ uses a large population for predicting Coronary Artery Syntax Score using carotid Ultrasound CIMT (AtheroEdge™) System. The method as claimed in claim 1 where in AtheroEdgeLink™ computes the ROC area between CIMT and Syntax Score for Coronary Artery Disease patients.

7. The method as claimed in claim 1 where in AtheroEdgeLink™ computes specificity of finding the CIMT above a threshold (in mm) on patients with Coronary Artery Disease.

8. The method as claimed in claim 1 where in AtheroEdgeLink™ can be used in any mobile system (such as AtheroMobile™), where, the Carotid Ultrasound and Coronary X-ray images can be stored in the cloud and displayed on the mobile unit (such as iPad or Samsung Tablets).

9. The method as claimed in claim 1 where in AtheroEdgeLink can be used in any mobile set-up (such as AtheroMobile™), where, the Carotid Ultrasound and Coronary X-ray images can be stored in the cloud and CIMT and Plaque Score computations can be implemented and displayed on the mobile unit (such as iPad or Samsung Tablets).

10. The method as claimed in claim 3 where in the automated CIMT is computed using CALEX sub-system.

11. The method as claimed in claim 3 where in the automated CIMT is computed using CAMES sub-system.

12. The method as claimed in claim 3 where in the automated CIMT is computed using CALSFORM sub-system.

13. The method as claimed in claim 3 where in the automated CIMT is computed using CARES sub-system.

14. The method as claimed in claim 3 where in the automated CIMT is computed using CMUDS sub-system.

15. The method as claimed in claim 1 where in the Carotid Ultrasound can be replaced by Aortic Arch B-mode or RF Ultrasound for computation of CIMT and Plaque Score.

16. The method as claimed in claim 1 where in the Carotid Ultrasound can be replaced by Brachial Ultrasound for computation of CIMT and Plaque Score.

17. The method as claimed in claim 1 where in the Carotid Ultrasound can be replaced by Peripheral Ultrasound for computation of CIMT and Plaque Score.

18. The method as claimed in claim 1 where in the Carotid Ultrasound can be replaced by Carotid Artery Wall Thickness (CWAT) from MRI and linked and predict the Syntax Score from the X-ray Coronaries.

19. The method as claimed in claim 1 where in the Carotid Ultrasound can be replaced by Carotid Artery Wall Thickness (CWAT) from CT and linked and predict the Syntax Score from the X-ray Coronaries.

20. The method as claimed in claim 17 including fusing image data corresponding to the Atherosclerosis burden data of the previous scan with the first image includes aligning the Atherosclerosis burden data corresponding to the current scan with the Atherosclerosis burden data corresponding to the previous scan.
